(19) United States
(12) Patent Application Publication
(10) Pub. No.: US 2020/0246718 A1
(43) Pub. Date: Aug. 6, 2020

(54) SPRAY APPARATUS FOR SPRAYING WATER AND DISCHARGING RESIDUAL WATER AND METHOD FOR CONTROLLING THE SAME

(71) Applicant: CJ 4DPLEX CO., LTD., Seoul (KR)

(72) Inventor: Hyeong Min KIM, Seoul (KR)

(21) Appl. No.: 16/857,496

(22) Filed: Apr. 24, 2020

Related U.S. Application Data
(62) Division of application No. 15/538,166, filed on Jun. 20, 2017.

(30) Foreign Application Priority Data
Dec. 31, 2014 (KR) 10-2014-0194846

(51) Int. Cl. A63J 5/02; A63J 25/00; B05B 7/08; B05B 14/00; B05B 7/00; B05B 7/24

(52) U.S. Cl. CPC A63J 5/025; A63J 25/00; B05B 7/0807; A63J 2005/007; B05B 7/0075; B05B 7/0081; B05B 7/2486; B05B 14/00

(57) ABSTRACT

The present invention relates to a spray apparatus and a method for controlling the spray apparatus in a system for controlling special effects in a 4D movie theater that are configured to spray water therefrom to provide rain and wind special effects, and more particularly, to a spray apparatus and a method for controlling the spray apparatus that are configured to drain the residual water remaining therein to the outside just after driving stops, while being engagedly operated with a content reproduced in a movie theater to provide rain and wind special effects for customers.

### CROSS REFERENCE TO RELATED APPLICATION

This application is a Divisional Application of U.S. application Ser. No. 15/538,166 filed Jun. 20, 2017 which is a national stage filing under 35 U.S.C § 371 of PCT application number PCT/KR2015/014375 filed on Dec. 29, 2015 which is based upon and claims the benefit of priority to Korean Patent Application No. 10-2014-0194846 filed on Dec. 31, 2014 in the Korean Intellectual Property Office. The disclosures of the above-listed applications are hereby incorporated by reference herein in their entireties.

### TECHNICAL FIELD

The present invention relates to a spray apparatus and a method for controlling the spray apparatus in a system for controlling special effects in a 4D movie theater that are configured to spray water therefrom to provide rain and wind special effects, and more particularly, to a spray apparatus and a method for controlling the spray apparatus that are configured to drain the residual water remaining therein to the outside just after driving stops, while being engagedly operated with a content reproduced in a movie theater to provide rain and wind special effects for customers.

### BACKGROUND ART

As a variety of movie contents have been supplied, recently, movie theaters at which the variety of movie contents are provided have been greatly developed. Especially, a lot of movie theater operators increase the number of 4D movie theaters providing physical effects as well as 3D images.

The 4D movie theaters provide given special effects engaged with a content currently reproduced for customers. For example, various motions and vibrations formed by motion chairs allow the customers to feel the special effects through their skin, thus inducing the increment of the immersive experiences of the customers during the content is reproduced. According to conventional practice, there is proposed Korean Patent Application Laid-open No. 2010-0093914 (on Aug. 26, 2010) wherein a water spraying apparatus is mounted on a motion chair, thus providing given special effects for customers.

On the other hand, the 4D movie theaters are provided with special effect equipment providing rain and wind special effects. So as to induce the rain and wind special effects, generally, the special effect equipment includes a sprayer for spraying water to the form of uniform particles and fans for distributing the water particles to a space in the movie theater.

By the way, the conventional sprayers fail to completely remove the residual water remaining in the interior thereof just after the driving stops, that is, the residual water remaining on the front and back sides of a pump for pumping water and the residual water remaining in a nozzle from which the water particles are sprayed. Even after the driving of the sprayer is finished, accordingly, the water flows through the nozzle, and even when a driving stop command is issued, the driving does not stop accurately at that time, so that the sprayer may be temporarily malfunctioned even after the driving stop command. Like this, such various problems occur in the control of the sprayer. Furthermore, the existence of the residual water makes components of the sprayer, such as a pipe, a pump, a nozzle and so on easily eroded to reduce the lifespan of the sprayer itself.

So as to remove the above-mentioned problems, accordingly, there is a definite need to effectively remove the residual water in a special effect control system having a spray apparatus.

To solve the problems occurring in a special effect control system having the spray apparatus, accordingly, the present invention is proposed to satisfy the technological requirements as mentioned above and further to provide additional technological elements which are not easily invented by the person having ordinary skill in the art.

### DISCLOSURE

### Technical Problem

Accordingly, the present invention has been made in view of the above-mentioned problems occurring in the prior art, and it is an object of the present invention to provide a spray apparatus that is capable of providing special effects for customers who watch a 4D content and effectively draining the residual water remaining therein just after driving is finished.

It is another object of the present invention to provide a spray apparatus that is capable of draining the residual water remaining in a pump or the residual water remaining in a nozzle tube according to the shapes and operating modes of solenoid valves.

It is still another object of the present invention to provide a spray apparatus that is capable of collecting the residual water to a water tank if the water tank is used as a water supply source.

It is yet another object of the present invention to provide a spray apparatus that is capable of connecting a water tank as a water supply source to a tap water pipe to refill the water tank with tap water, thus allowing the water required for special effects to be gently supplied.

### Technical Solution

To accomplish the above-mentioned objects. according to a first aspect of the present invention, there is provided a spray apparatus including: a sprayer controller engagedly operating with a content reproduced so as to control a sprayer; and the sprayer for spraying water or draining residual water under the control of the sprayer controller.

According to the present invention, desirably, the sprayer includes: a water inlet pipe connected to a water supply source on one end thereof and connected to a solenoid valve on the other end thereof; the solenoid valve connected to the water inlet pipe on one end thereof and connected to a nozzle tube and a drain pipe on the other end thereof in such a manner as to be controlled in the connection state thereof by means of the sprayer controller, the nozzle tube connected to the solenoid valve on one end thereof and connected to nozzles on the other end thereof; and the drain pipe connected to the solenoid valve on one end thereof and having a drain hole formed on the other end thereof.

According to the present invention, desirably, through the control of the sprayer controller, the solenoid valve is controlled to a first mode so that the water inlet pipe and the nozzle tube are connected with each other or to a second mode so that the drain pipe and the nozzle tube are connected with each other.

According to the present invention, desirably, the spray apparatus further includes a pump located on the water inlet pipe to pump the water supplied from the water supply source.

According to the present invention, desirably, the water supply source is a water tank for storing a given capacity of water, and the other end of the drain pipe is connected to the water tank.

According to the present invention, desirably, the spray apparatus further includes an auxiliary pump located on the drain pipe to pump the drained water.

According to the present invention, desirably, the sprayer includes: a water inlet pipe connected to a water supply source on one end thereof and connected to a first solenoid valve on the other end thereof; the first solenoid valve connected to the water inlet pipe on one end thereof and connected to a connection pipe on the other end thereof in such a manner as to be controlled in the connection state thereof by means of the sprayer controller; the connection pipe connected to the first solenoid valve on one end thereof and connected to a second solenoid valve on the other end thereof; the second solenoid valve connected to the connection pipe on one end thereof and connected to a nozzle tube and a drain pipe on the other end thereof in such a manner as to be controlled in the connection state thereof by means of the sprayer controller; the nozzle tube connected to the second solenoid valve on one end thereof and connected to nozzles on the other end thereof; and the drain pipe connected to the second solenoid valve on one end thereof and having a drain hole formed on the other end thereof.

According to the present invention, desirably, through the control of the sprayer controller, the first solenoid valve is controlled to a first mode so that the water inlet pipe and the connection pipe are connected with each other or to a second mode so that the water inlet pipe and the connection pipe are closed.

According to the present invention, desirably, through the control of the sprayer controller, the second solenoid valve is controlled to any one of a first mode so that the connection pipe and the nozzle tube are connected with each other, a second mode so that the connection pipe and the drain pipe are connected with each other, and a third mode so that the drain pipe and the nozzle tube are connected with each other.

According to the present invention, desirably, the spray apparatus further includes a pump located on the water inlet pipe or the connection pipe to pump the water supplied.

According to the present invention, desirably, the water supply source is a water tank for storing a given capacity of water, and the other end of the drain pipe is connected to the water tank.

According to the present invention, desirably, the spray apparatus further includes an auxiliary pump located on the drain pipe to pump the drained water.

According to the present invention, desirably, the water supply source is a water tank for storing a given capacity of water, and the other end of the first solenoid valve is connected to a refilling pipe, the refilling pipe being connected to tap water on one end thereof and connected to the first solenoid valve on the other end thereof, so that through the control of the sprayer controller, the first solenoid valve is controlled to a third mode so that the refilling pipe and the water inlet pipe are connected with each other.

According to the present invention, desirably, the spray apparatus further includes a water level sensor for monitoring the water level of the water tank, and if the water level of the water tank is less than a given value, the first solenoid valve is controlled to the third mode by means of the sprayer controller to refill the water tank with the water.

According to the present invention, desirably, the spray apparatus further includes a pump located on the water inlet pipe to pump the water supplied, wherein the water supply source is a water tank for storing a given capacity of water, and the other end of the first solenoid valve is connected to a water recovering pipe, the water recovering pipe being connected to the water tank on one end thereof and connected to the first solenoid valve on the other end thereof, so that through the control of the sprayer controller, the first solenoid valve is controlled to a fourth mode so that the water recovering pipe and the water inlet pipe are connected with each other.

To accomplish the above-mentioned objects, according to a second aspect of the present invention, there is provided a method for controlling the spray apparatus, the method including the steps of: (a) controlling the solenoid valve to the first mode so that the water inlet pipe and the nozzle tube are connected with each other to start spraying; and (b) controlling the solenoid valve to the second mode so that the drain pipe and the nozzle tube are connected with each other to stop the spraying and to drain the residual water remaining in the nozzle tube.

To accomplish the above-mentioned objects, according to a third aspect of the present invention, there is provided a method for controlling the spray apparatus, the method including the steps of: (a) controlling the first solenoid valve to the first mode so that the water inlet pipe and the connection pipe are connected with each other and controlling the second solenoid valve to the first mode so that the connection pipe and the nozzle tube are connected with each other to start spraying; and (b) controlling the first solenoid valve to the second mode so that the water inlet pipe and the connection pipe are closed and controlling the second solenoid valve to the second mode so that the connection pipe and the drain pipe are connected with each other to drain the residual water remaining in the connection pipe.

According to the present invention, desirably, the step (b) includes the steps of: controlling the first solenoid valve to the second mode so that the water inlet pipe and the connection pipe are closed, and controlling the second solenoid valve to the third mode so that the drain pipe and the nozzle tube are connected with each other to drain the residual water remaining in the nozzle tube.

### Advantageous Effects

According to the present invention, the spray apparatus can effectively drain the residual water remaining therein, thus preventing the leakage of water therefrom after the driving stop command has been issued. suppressing the erosion caused by the leakage of water, and extending the lifespan thereof.

Additionally, the spray apparatus can collect the residual water to the water tank, thus preventing the water resource from being unnecessarily consumed. During the residual water is collected to the water tank, at this time, the water in the water tank can be continuously circulated, thus preventing the water in the water tank from going bad.

Further, the spray apparatus can allow the water tank as the water supply source to receive water from the tap water, so that even if the water level of the water tank is lowered, the water supply can be gently performed.

### DESCRIPTION OF DRAWINGS

FIG. 1 is a schematic view showing the state wherein a special effect control system having a spray apparatus according to present invention is disposed in a movie theater.

FIG. 2a illustrates detailed configuration of a sprayer which contains one solenoid valve.

FIG. 2b illustrates detailed configuration of a sprayer which contains two solenoid valves.

FIG. 3a illustrates the states of a sprayer before driving according to the first embodiment.

FIG. 3b illustrates the states of a sprayer during driving according to the first embodiment.

FIG. 3c illustrates the states of a sprayer just after driving according to the first embodiment.

FIG. 4a illustrates the states of a sprayer before driving according to the second embodiment.

FIG. 4b illustrates the states of a sprayer during driving according to the second embodiment.

FIG. 4c illustrates the states of a sprayer just after driving according to the second embodiment.

FIG. 5a illustrates the states of a sprayer before driving according to the third embodiment.

FIG. 5b illustrates the states of a sprayer during driving according to the third embodiment.

FIG. 5c illustrates the states of a sprayer just after driving according to the third embodiment FIG. 6a illustrates the states of a sprayer before driving according to the fourth embodiment.

FIG. 6b illustrates the states of a sprayer during driving according to the fourth embodiment.

FIG. 6c illustrates the states of a sprayer just after driving according to the fourth embodiment FIG. 7a illustrates the states of a sprayer before driving according to the fifth embodiment.

FIG. 7b illustrates the states of a sprayer during driving according to the fifth embodiment.

FIG. 7c illustrates the states of a sprayer just after driving according to the fifth embodiment.

FIG. 7d illustrates the states of a sprayer refilling a water tank with water after driving according to the fifth embodiment.

FIG. 8 is a block diagram showing the state wherein the spray apparatus according to the present invention is driven in the special effect control system.

### MODE FOR INVENTION

Hereinafter, the objects, technological configurations, and operating effects of the present invention will be more clearly understood through the detailed description with reference to the attached drawings. The present invention will be in detail described with reference to the attached drawings.

The present invention may be modified in various ways and may have several exemplary embodiments. Specific exemplary embodiments of the present invention are illustrated in the drawings and described in detail in the detailed description. However, this does not limit the invention within specific embodiments and it should be understood that the invention covers all the modifications, equivalents, and replacements within the idea and technical scope of the invention.

The functional blocks illustrated in the drawings and explained below are just exemplary in the present invention. Of course, other functional blocks may be used within the scope of the invention. According to the present invention, further. one or more functional blocks are illustrated as individual blocks, but one or more of the functional blocks may be the combination of various hardware and software components performing the same function as each other.

In this application, terms, such as “comprise”, “include”, or ‘have”, are intended to designate those characteristics, numbers, steps, operations, elements, or parts which are described in the specification, or any combination of them that exist, and it should be understood that they do not preclude the possibility of the existence or possible addition of one or more additional characteristics, numbers, steps, operations, elements, or parts, or combinations thereof.

Further, the term ‘coupled’ or ‘connected’, as used herein, is defined as connected, although not necessarily directly, and not necessarily mechanically. To the contrarily, the term ‘directly coupled’ or ‘directly connected’, as used herein, is defined as connected without having any component disposed therebetween.

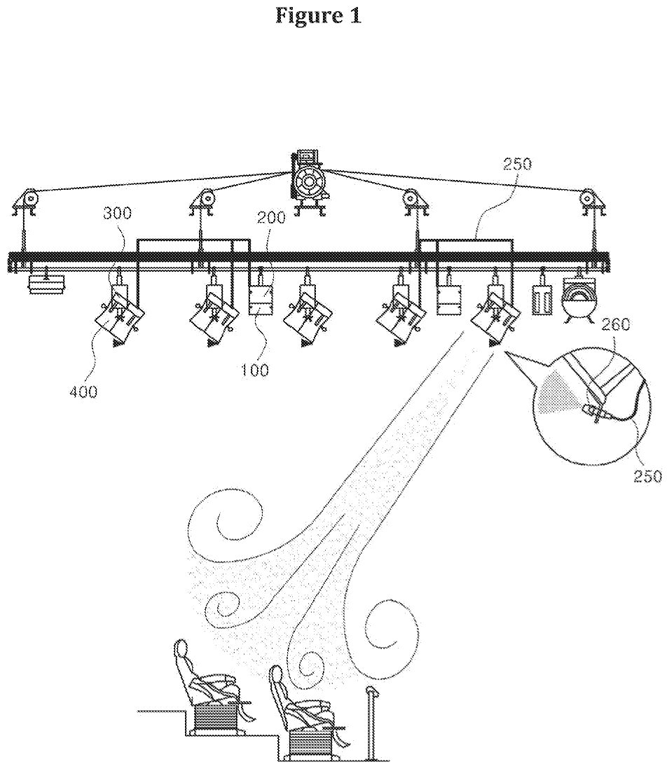

Hereinafter, an explanation on the configuration of a special effect control system having a spray apparatus according to present invention will be given with reference to FIG. 1.

As mentioned above, the present invention relates to a spray apparatus providing special effects in a movie theater. Among the special effects, especially, rain and wind special effects are provided for customers of the movie theater. The spray apparatus according to the present invention is engagedly driven with a content currently reproduced, and of course, the time point for driving the spray apparatus according to the present invention is set previously by an operator.

For example, if a scene on which it showers with strong wind is reproduced within the content, the spray apparatus according to the present invention controls a quantity of water sprayed and spraying time through a sprayer controller, thus providing the special effects, so that the customers feel as if it showers with strong wind within the movie theater. Furthermore, the spray apparatus according to the present invention is cooperatively driven with a fan generating wind, thus more drastically expressing the rain and wind special effects. Through the spray apparatus according to the present invention, for example, water is sprayed in the direction of the wind generated from the fan, thus more effectively providing the rain and wind special effects.

In the conventional practice, on the other hand, spray apparatuses are mounted on all of seats in a movie theater so as to provide the rain and wind special effects to customers. For example, water is pumped to a nozzle disposed above a headrest of the seat and sprayed to the head of the customer. Otherwise, a spray part is disposed on a backrest of a front seat to spray water to the face of the customer. However, the conventional spray apparatuses are configured just to spray water to the customers, but they fail to provide the realistic rain and wind special effects.

Besides, the spray apparatuses should be disposed on every seat, thus requiring high installation costs.

Also, if a driving stop command is issued, the spraying operation should stop, but in case of most of the conventional spray apparatuses, water is kept spraying due to a pumping pressure, or the residual water remaining in the nozzle leaks to the outside.

So as to remove the problems occurring in the special effect control system providing the rain and wind special effects, the spray apparatus according to the present invention has a configuration as shown in FIG. 1.

As shown in FIG. 1. the spray apparatus according to the present invention largely includes a sprayer controller 100 and a sprayer 200.

First, the sprayer controller 100 controls the sprayer 200 and also controls all of components in the spray apparatus in the state of being engagedly operated with the content reproduced currently in a movie theater.

In the detailed description, particularly, the control of the sprayer 200 through the sprayer controller 100 means that the connected states of solenoid valves 220 and 240, the driving start and stop of a pump 230 and an auxiliary pump 280, as the components contained in the sprayer 200 as will be discussed later, are controlled.

According to the present invention, the sprayer controller 100 includes at least one operation unit for generally controlling the sprayer 200, and at this time, the operation unit may include a general-purpose central processing unit (CPU), programmable devices (CPLD and FPGA) designed for a special purpose, application specific integrated circuit (ASIC), or a micro controller chip.

On the other hand, the sprayer 200 is a unit for spraying water under the control of the sprayer controller 100, and at this time, it should be understood that spraying means water is spread to the air in the form of water particles of a given size or under.

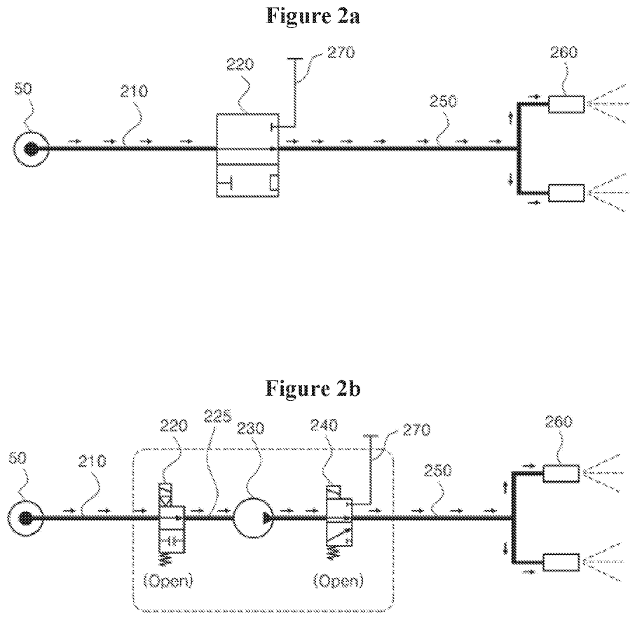

Further, the sprayer 200 includes one or more solenoid valves 220 and 240, a pump 230, a nozzle 260, and a pipe connecting the respective components, and a detailed explanation of the components of the sprayer 200 will be given later with reference to FIGS. 2a and 2b.

On the other hand, as mentioned above, the spray apparatus according to the present invention, that is, the sprayer 200 is cooperatively driven with a fan 400, and the fan 400 is controlled by a fan controller 300.

So as to make the present invention easily understood, on the other hand, the process for controlling one spray apparatus is described, but when the present invention is really applied, a plurality of spray apparatuses are driven. Further, a plurality of sprayer controllers 100 can totally control a plurality of sprayers 200. In more detail, the total control means that the respective sprayer controllers control the corresponding sprayers at the same time, they selectively control some of the plurality of sprayers, and they individually control the detailed components of one sprayer.

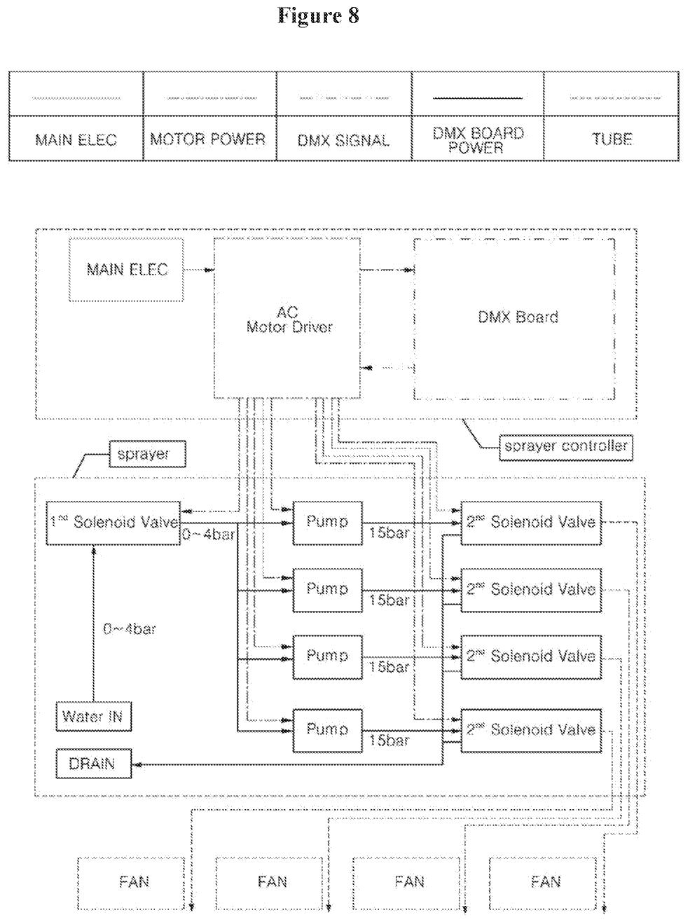

FIG. 8 is a block diagram showing the operations of the sprayer controller 100 and the sprayer 200 in the special effect control system. Particularly, the sprayer 200 includes a first solenoid valve 220, a plurality of pumps 230, and a plurality of second solenoid valves 240. The sprayer controller 100 includes a DMX board and an AC motor driver to control the components in the sprayer 200 and receives required power from MAIN ELEC.

In more detail, the sprayer 200 includes, at the interior thereof, a water inlet pipe, the first solenoid valve, the plurality of pumps, the plurality of second solenoid valves, and nozzle tubes.

The components of the sprayer 200 are controlled by the sprayer controller 100.

On the other hand, the nozzle tubes of the sprayer 200 are connected to fans 400, and at this time, the connection of the nozzle tubes with the fans 400 means that the nuzzle tubes are directed toward the advancing direction of the wind generated from the fans 400 so that the water sprayed from the nozzle tubes is evenly distributed in a movie theater.

Accordingly, it is important to determine the position of the spray apparatus in the movie theater, and according to the present invention, the spray apparatus is located on a relatively large space in the movie theater, desirably, on a ceiling surface of the movie theater. Of course, it should be understood that the location of the spray apparatus is not limited thereto.

FIG. 1 shows the spray apparatus according to the present invention located on the ceiling surface of the movie theater. Even if a relatively small number of spray apparatuses are located on the ceiling surface, the rain and wind special effects can be provided for a large number of customers, thus requiring a lower installation cost when compared with the sprayers installed on every seat. If the spray apparatuses are located on the ceiling surface, further, the customers feel as if they are exposed to rain and wind outdoors, thus providing better rain and wind special effects than the conventional spray apparatuses.

On the other hand, as shown in FIG. 1, the sprayer controllers 100, the sprayers 200, the fan controllers 300, and the fans 400 are all located on the ceiling surface of the movie theater, but they are not necessarily located on the same ceiling surface. Especially, if the sprayer controllers 100 and the fan controllers 300 are provided under wire or wireless network environments capable of transmitting and receiving control commands to and from the sprayers 200 and the fans 400, they can be located inside or outside the movie theater.

Now, the detailed configuration of the sprayer 200 according to the present invention will be explained with reference to FIGS. 2a and 2b.

Referring to FIG. 2a, the sprayer 200 includes a water inlet pipe 210, a solenoid valve 220, a nozzle tube 250, nozzles 260 and a drain pipe 270.

The components will be explained in the order of their location in the advancing direction of water.

First, the water inlet pipe 210 connects a water supply source and the solenoid valve 220 with each other. The water inlet pipe 210 is a water passage directly connected to the water supply source, and at this time, the water supply source includes tap water continuously supplied through a constant pressure and a water tank in which a given quantity of water is stored, which will be discussed later.

On the other hand, the solenoid valve 220 is connected to the water inlet pipe 210 on one end thereof and connected to the nozzle tube 250 and the drain pipe 270 on the other end thereof.

Further, the solenoid valve 220 is controlled to a first mode so that the water inlet pipe 210 and the nozzle tube 250 are connected with each other by the control of the sprayer controller 100 or to a second mode so that the drain pipe 270 and the nozzle tube 250 are connected with each other by the control of the sprayer controller 100. On the other hand, if the water supply source is the water tank, the other end of the drain pipe 270 is connected to the water tank to collect the drained water to the water tank.

If the solenoid valve 220 is controlled to the second mode, on the other hand, the nozzle tube 250 and the drain pipe 270 can drain residual water by means of the pressure difference therebetween. That is, if the pressure of the drain pipe 270 is lower than that of the nozzle tube 250, the solenoid valve 220 is controlled to the second mode, and at the same time, the residual water in the nozzle tube 250 moves to the drain pipe 270 and is then removed.

Further, the water inlet pipe 210 includes a pump for pumping the water supplied from the water supply source to gently supply the water to the solenoid valve 220. Furthermore, the drain pipe 270 includes an auxiliary pump for pumping the water drained.

Next, FIG. 2b shows the detailed configuration of the sprayer 200 having first and second solenoid valves 220 and 240.

Referring to FIG. 2b, the sprayer 200 includes the water inlet pipe 210, the first solenoid valve 220, a connection pipe 225, a pump 230, the second solenoid valve 240, the nozzle tube 250, the nozzles 260 and the drain pipe 270.

The components will be explained in the order of their location in the advancing direction of water.

First, the water inlet pipe 210 connects a water supply source and the first solenoid valve 220 with each other. The water inlet pipe 210 is a water passage directly connected to the water supply source, and at this time, the water supply source includes tap water continuously supplied through a constant pressure and a water tank in which a given quantity of water is stored, which will be discussed later.

On the other hand, the first solenoid valve 220 is connected to the water inlet pipe 210 on one end thereof and connected to the second solenoid valve 240 on the other end thereof.

Particularly, the first solenoid valve 220 and the second solenoid valve 240 are connected with each other by means of the connection pipe 225. On the other hand, the first solenoid valve 220 is controlled to a first mode so that the water inlet pipe 210 and the connection pipe 225 are connected with each other by the control of the sprayer controller 100 or to a second mode so that the water inlet pipe 210 and the connection pipe 225 are closed by the control of the sprayer controller 100.

That is, the first solenoid valve 220, which is located at the entrance of the water passage, serves to open or close the water passage according to the control commands of the sprayer controller 100. On the other hand, the solenoid valve mentioned in the present invention has two or more water passage positions so that the water passage positions can be selectively changed according to the control commands of the sprayer controller 100. Accordingly, as shown in FIG. 2b, the first solenoid valve 220 has an open water passage position at which the water passage is open and a closed water passage position at which the water passage is closed.

On the other hand, the connection pipe 225 is connected to the first solenoid valve 220 on one end thereof and to the second solenoid valve 240 on the other end thereof.

On the other hand, the pump 230 is located on the connection pipe 225, and through the pump 230, basically, a water passage environment is provided to produce a pressure difference by means of power so that water is pumped and moved through the pressure difference. On the other hand, the pump 230 is located inside or outside the connection pipe 225 and further includes water pipes connected to the first solenoid valve 220 and the second solenoid valve 240.

Accordingly, the pump 230 as will be explained below means the pump having the water pipes connected to other components and the driver for generating the pressure difference in the water pipe.

Driving start and stop of the pump 230 are controlled by the sprayer controller 100 and especially engagedly operated with the first mode and the second mode of the first solenoid valve 220. In more detail, if the first solenoid valve 220 is at the first mode, the driving of the pump 230 starts to suck water from the water supply source, and if the first solenoid valve 220 is at the second mode, the driving of the pump 230 stops.

On the other hand, the pump 230 is not necessarily located on the connection pipe 225, and in some cases, the pump 230 is located on the water inlet pipe 210 to pump the water supplied from the water supply source.

Next, the second solenoid valve 240 is connected to the connection pipe 225 on one end thereof and connected to the nozzle tube 250 and the drain pipe 270 on the other end thereof. The second solenoid valve 240 has an important function of selectively connecting three-directional water passages. For example, the second solenoid valve 240 is controlled to a first mode so that the connection pipe 225 and the nozzle tube 250 are connected with each other by the control of the sprayer controller 100 or to a second mode so that the connection pipe 225 and the drain pipe 270 are connected with each other by the control of the sprayer controller 100.

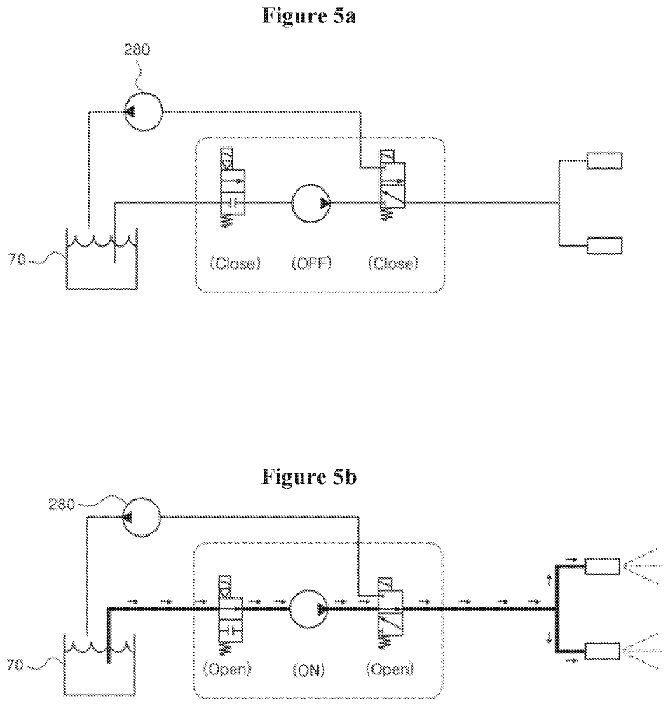

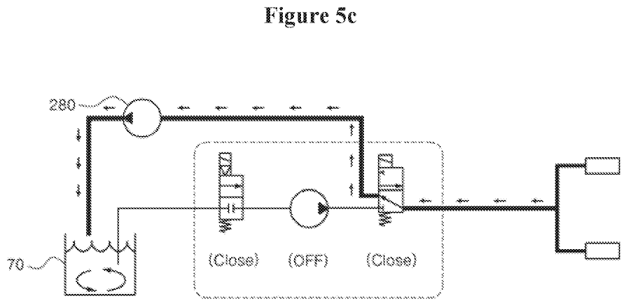

On the other hand, the second solenoid valve 240 is configured to drain the residual water remaining in the pump 230, more accurately, the driver of the pump 230, or the residual water remaining in the connection pipe 225, through the drain pipe 270 or to drain the residual water remaining in the nozzle tube 250, through the drain pipe 270, which will be discussed later with reference to FIGS. 5a to 5c.

On the other hand, the other end of the second solenoid valve 240 is connected to the nozzle tube 250 and the drain pipe 270.

First, the connection state of the nozzle tube 250 with the pump 230 is open or closed according to the control of the second solenoid valve 240, and one end of the nozzle tube 250 is connected to the nozzles 260. At this time, the nozzles 260 are components for changing water to the form of particles to distribute the water particles to the space, and each nozzle 260 has a plurality of injection holes formed thereon so that the quantity of water sprayed can be adjusted in accordance with the sizes of the injection holes, that is, the diameters or areas of the injection holes. Further, each nozzle 260 further includes a check valve for restricting the flow of water only in one direction.

On the other hand, the connection state of the drain pipe 270 with the pump 230 is open or closed according to the control of the second solenoid valve 240, and the drain pipe 270 has a drain hole formed on one end thereof to drain the residual water therethrough.

On the other hand, the structures of the solenoid valves as mentioned in the present invention can be changed according to the intention of a manufacturer. For example, only if the water supply source, the pump and the nozzles are effectively connected to each other through the control of the solenoid valves even under the condition wherein the number of positions of the solenoid valves is differently changed, the solenoid valves changed in structures can be applied in the same manner as the present invention.

The detailed configuration of the sprayer 200 has been explained above.

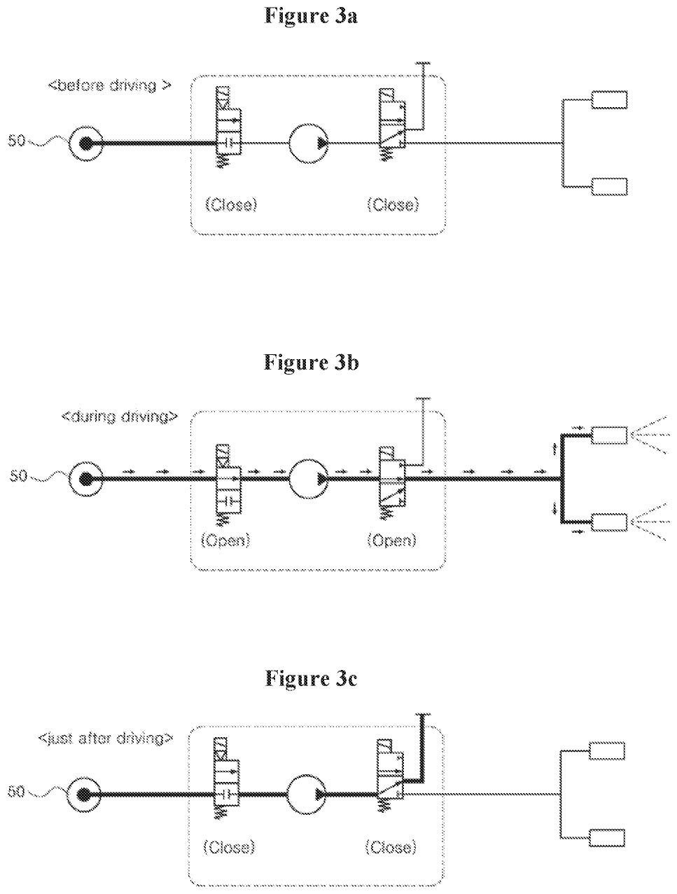

Now, a method for controlling the spray apparatus according to the present invention will be explained with reference to FIGS. 3a to 7d.

### First Embodiment

FIGS. 3a to 3c show the states of the spray apparatus according to the present invention before driving, during driving, and just after driving. On the other hand, the water supply source in FIGS. 3a to 3c are tap water.

A method for controlling the spray apparatus according to the present invention is conducted in accordance with the controlled states of the first solenoid valve 220 and the second solenoid valve 240.

Referring first to the sprayer 200 before the driving, the first solenoid valve 220 of the sprayer 200 is set to the second mode by means of the sprayer controller 100 so that water does not pass through the water passage after the first solenoid valve 220. Since the constant water pressure exists through the tap water as the water supply source, water is supplied from the tap water so that the water exists in the water inlet pipe 210. However, the first solenoid valve 220 serves to block the flow of water from the water passage after the water inlet pipe 210.

During the driving of the sprayer 200, on the other hand, the first solenoid valve 220 is set to the first mode and the second solenoid valve 240 is set to the first mode so that the connection pipe 225 and the nozzle tube 250 are connected with each other by means of the sprayer controller 100, thus allowing the water passage to be connected from the water supply source to the nozzles 260. At this time, since the water is supplied from the tap water by the constant pressure, the sprayer 200 can be driven even if the pump 230 is not operated by the control of the sprayer controller 100. However, the pump 230 functions to form a given pressure, and accordingly. even if the water is supplied by the water pressure of the tap water, the pressure of water can be raised through the driving of the pump 230, thus optimizing the spraying effects. Accordingly, the driving of the pump 230 can be selectively conducted.

Lastly, the first solenoid valve 220 is set to the second mode and the second solenoid valve 240 is set to the second mode so that the connection pipe 225 and the drain pipe 270 are connected with each other by means of the sprayer controller 100, thus stopping the driving of the sprayer 200. After the driving of the sprayer 200 stops, residual water, which is not discharged through the nozzle tube 250, remains in the pump 230 or the connection pipe 225, and the residual water makes the pump 230 eroded to reduce the lifespan of the spray apparatus. Just after the sprayer 200 is driven, further, the residual water, which is not discharged through the nozzle tube 250, exists under a given pressure in the pump 230, so that the residual water having the given pressure applies overload to the pump 230 to reduce lifespan of the spray apparatus.

The present invention provides a method for effectively draining the residual water, and accordingly, the second solenoid valve 240 is set to the second mode in which the connection pipe 225 and the drain pipe 270 are connected with each other by means of the sprayer controller 100, so that the residual water remaining in the pump 230 or the connection pipe 225 is drained to the outside. At this time, the pump 230 is driven by the sprayer controller 100 to drain the residual water therethrough. On the other hand, the drain pipe 270 has an auxiliary pump 280 located thereon to allow the residual water drained to be more easily sucked thereto.

### Second Embodiment

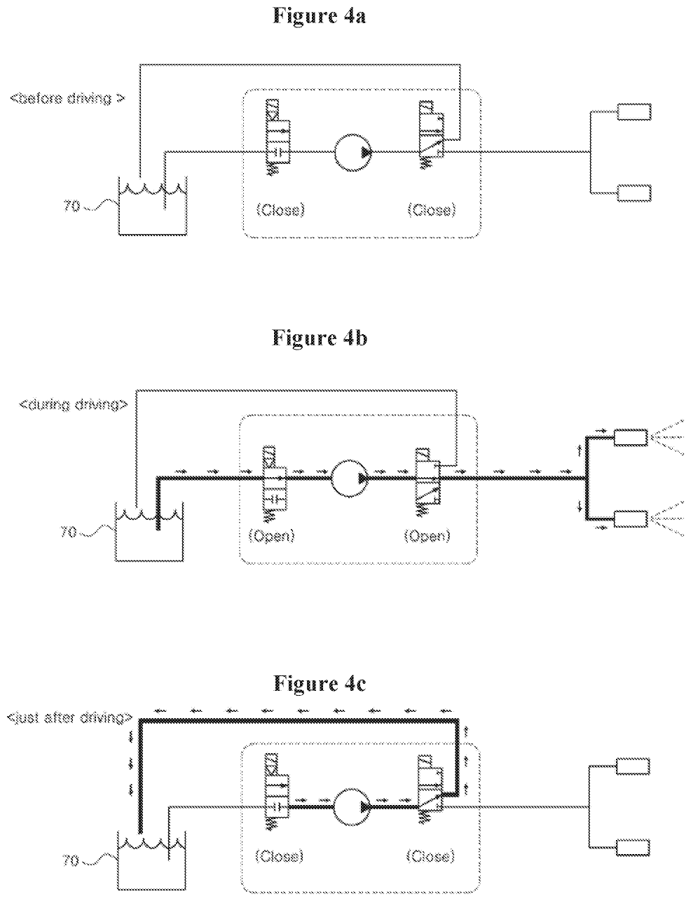

FIGS. 4a to 4c show the states of the spray apparatus according to the present invention before driving, during driving, and just after driving. On the other hand, the water supply source in FIGS. 4a to 4c are a water tank.

A method for controlling the spray apparatus according to the present invention is conducted in accordance with the controlled states of the first solenoid valve 220 and the second solenoid valve 240.

Referring first to the sprayer 200 before the driving, the first solenoid valve 220 of the sprayer 200 is set to the second mode by means of the sprayer controller 100 so that water does not pass through the water passage after the first solenoid valve 220. Since the water supply source is the water tank, the constant water pressure does not exist in the water tank, unlike the tap water. In some cases, accordingly, the state before the sprayer 200 is driven means the state in which no separate control command is issued from the sprayer controller 100. That is, the sprayer 200 can be maintained to the state before driven irrespective of the mode of the first solenoid valve 220. During the driving of the sprayer 200, on the other hand, the first solenoid valve 220 is set to the first mode and the second solenoid valve 240 is set to the first mode so that the connection pipe 225 and the nozzle tube 250 are connected with each other by means of the sprayer controller 100, thus allowing the water passage to be connected from the water tank to the nozzles 260. At this time, since the water is not continuously supplied from the water tank by the constant pressure thereof, unlike the tap water, the pump 230 is driven by the control of the sprayer controller 100 to suck the water from the water tank.

Lastly, the first solenoid valve 220 is set to the second mode and the second solenoid valve 240 is set to the second mode so that the connection pipe 225 and the drain pipe 270 are connected with each other by means of the sprayer controller 100, thus stopping the driving of the sprayer 200. In the same manner as the first embodiment of the present invention, after the driving of the sprayer 200 stops, the residual water remaining in the pump 230 is discharged through the drain pipe 270. At this time, as shown in FIG. 4, the other end of the drain pipe 270 is connected to the water tank so that the discharged residual water is collected to the water tank. Like this, if the residual water remaining in the connection pipe 225 and the pump 230 is collected to the water tank, the unnecessary consumption of water resource can be minimized and the problems caused by the residual water in the connection pipe 225 and the pump 230 can be removed. Further, the residual water is collected to the water tank and circulated in the water tank, thus preventing the water from going bad.

### Third Embodiment

FIGS. 5a to 5c show the configuration of the spray apparatus according to the present invention wherein the residual water remaining in the nozzle tube 250 is discharged through the change in the structure of the second solenoid valve 240.

The basic configuration of the spray apparatus according to the present invention in FIGS. 5a to 5c are the same as in FIGS. 4a to 4c, except that the structure of the second solenoid valve 240 is different from that in FIGS. 4a to 4c. According to the spray apparatus as shown in FIGS. 4a to 4c, the second solenoid valve 240 is controlled to the first mode wherein the connection pipe 225 is connected with the nozzle tube 250 or to the second mode wherein the connection pipe 225 is connected with the drain pipe 270. but according to the spray apparatus as shown in FIGS. 5a to 5c, the second solenoid valve 240 is controlled to the first mode wherein the connection pipe 225 is connected with the nozzle tube 250 or to a third mode wherein the drain pipe 270 is connected with the nozzle tube 250.

When the third embodiment of the present invention is compared with the second embodiment of the present invention, the sprayer 200 before and during the driving is controlled in the same manner as each other, but as mentioned above, the structure of the second solenoid valve 240 according to the third embodiment of the present invention is different from that according to the second embodiment of the present invention.

Just after the driving of the sprayer 200, the residual water exists in the pipe between the second solenoid valve 240 and the nozzles 260, that is, in the nozzle tube 250, and the third embodiment of the present invention can be applied effectively to drain the residual water remaining in the nozzle tube 250.

Especially, the water pressure of the nozzle tube 250 is substantially kept high just after the sprayer 200 is driven, and at this time, if the second solenoid valve 240 is controlled to connect the drain pipe 270 having no water pressure with the nozzle tube 250, the residual water in the nozzle tube 250 becomes sucked to the drain pipe 270 by means of an instant pressure difference generated between the nozzle tube 250 and the drain pipe 270. Accordingly, the third embodiment of the present invention can effectively drain the residual water by means of the instant pressure difference and further prevent the leakage of the residual water from the nozzles 260.

Furthermore, if the auxiliary pump 280 is located on the drain pipe 270, the residual water remaining in the nozzle tube 250 can be more effectively drained.

*116On the other hand, it is obvious to the person having ordinary skill in the art that the third embodiment of the present invention can be applied to the second embodiment (having the water tank as the water supply source) and the first embodiment (having the tap water as the water supply source) in the same manner as each other.

### Fourth Embodiment

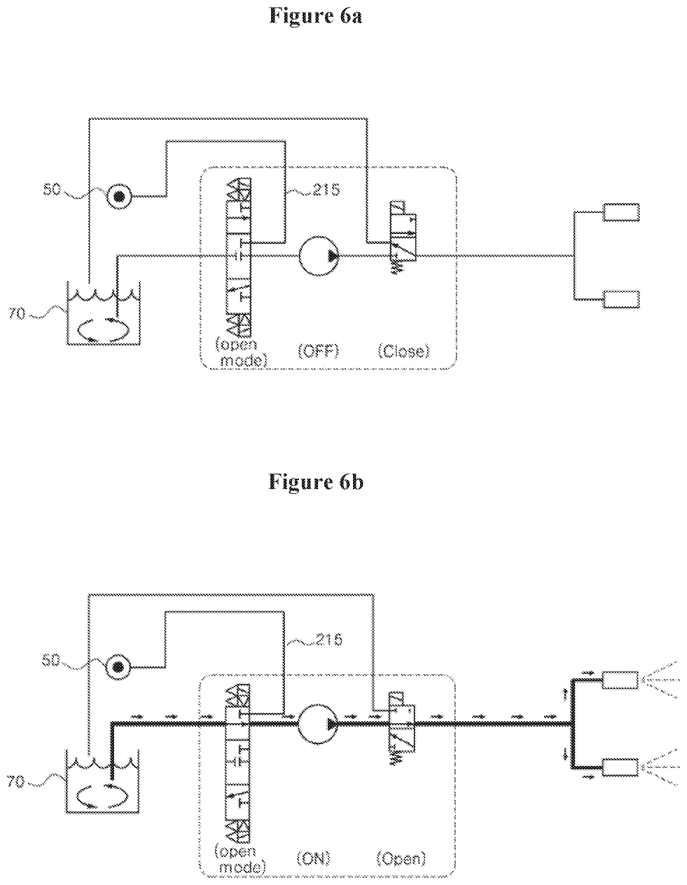

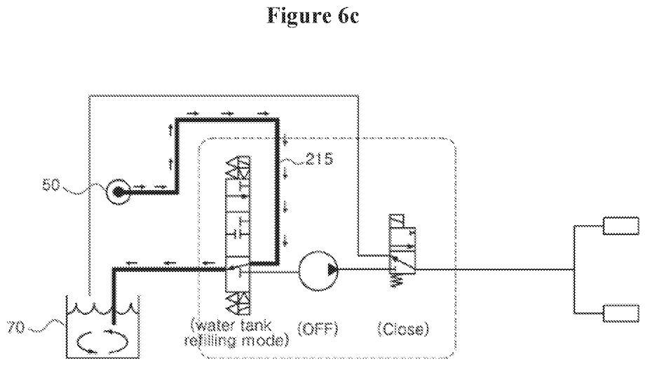

FIGS. 6a to 6c show the configuration of the spray apparatus according to the present invention wherein the tap water is connected to the water tank used as the water supply source to refill the water tank with water through the change in the structure of the first solenoid valve 220.

The basic configuration of the spray apparatus according to the present invention in FIGS. 6a to 6c are the same as in FIGS. 5a to 5c, except that the structure of the first solenoid valve 220 is different from that in FIG. 5a to 5c. According to the spray apparatus as shown in FIGS. 5a to 5c, the first solenoid valve 220 is controlled to the first mode wherein the water inlet pipe 210 and the connection pipe 225 are connected with each other or to the second mode wherein the water inlet pipe 210 and the connection pipe 225 are cut off, thus just serving to open and close the water passage, but according to the spray apparatus as shown in FIGS. 6a to 6c, a refilling pipe 215 (whose one end is connected to the tap water) is further connected to the other end of the first solenoid valve 220, and the first solenoid valve 220 is controlled to the third mode wherein the refilling pipe 215 is connected with the water inlet pipe 210.

As shown in FIGS. 6a to 6c, that is, while the first solenoid valve 220 is receiving the water from the water tank, it connects the tap water to the water tank to refill the water tank with water if the water level of the water tank is lowered.

The connection of the tap water with the water tank enables the water from the tap water to be supplied if the water level of the water tank is lowered, so that the sprayer 200 can be driven without any stop.

On the other hand, the water tank is provided with a water level sensor for monitoring the water level thereof. The water level sensor serves to continuously monitor the capacity of water stored in the water tank and to transmit the monitoring information to the sprayer controller 100. If the water level of the water tank is less than a given value, the first solenoid valve 220 is controlled to connect the tap water with the water tank under the control of the sprayer controller 100. If the water level of the water tank is greater than the given value, contrarily, the first solenoid valve 220 is controlled to release the connected state between the tap water and the water tank and to connect the water tank and the pump 230 with each other again under the control of the sprayer controller 100.

### Fifth Embodiment

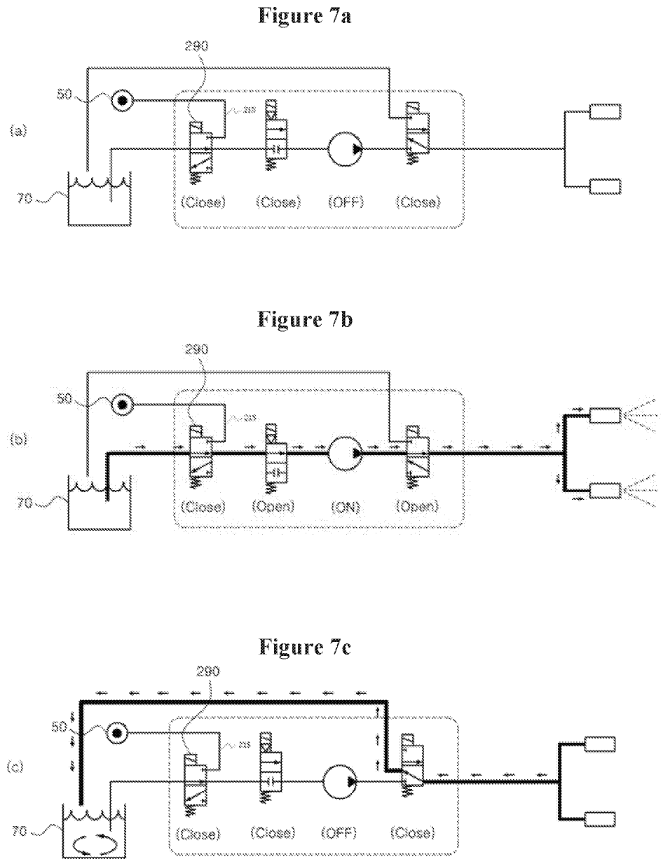

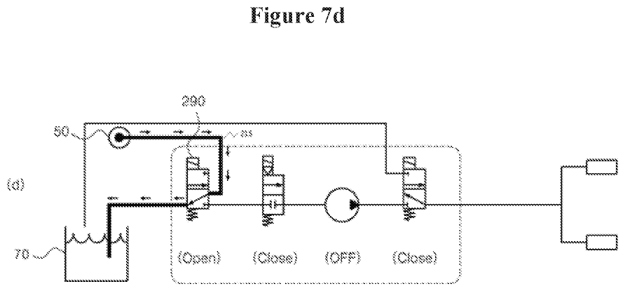

On the other hand, FIGS. 7a to 7d are views showing other configurations of the spray apparatus according to the present invention wherein the tap water is connected to the water tank to refill the water tank with water.

The basic configurations of FIGS. 7a to 7d are the same as the configuration as shown in FIGS. 4a to 4c except that a third solenoid valve 290 is further located between the first solenoid valve 220 and the water supply source (water tank) to connect the water tank with the tap water. At this time, the third solenoid valve 290 is connected to the water inlet pipe 210 on one end thereof and to the refilling pipe 215 on the other end thereof. Further, the refilling pipe 215 is of course connected to the tap water.

FIG. 7a shows the state wherein the first solenoid valve 220 is at the second mode and the driving of the pump 230 stops so that the driving of the sprayer 200 stops. At this time, it is not necessary to control the second solenoid valve 240 or the third solenoid valve 290. However, desirably, the second solenoid valve 240 is at the second mode and the third solenoid valve 290 is at a closed mode, thus completely blocking the water supply to the nozzles 260.

FIG. 7b shows the state wherein the first solenoid valve 220 and the third solenoid valve 290 are at the open mode and the second solenoid valve 240 is at the first mode so that the pump 230 is operated to drive the sprayer 200.

FIG. 7c shows the state wherein the first solenoid valve 220 is at the closed mode and the second solenoid valve 240 are at the third mode in which the nozzle tube 250 and the drain pipe 270 are connected with each other under the state of FIG. 7b so that the residual water in the nozzle tube 250 is drained to the water tank.

FIG. 7d shows the state wherein the third solenoid valve 290 is controlled under the state of FIG. 7c to refill the water tank with water. The third solenoid valve 290 being at the open mode is controlled to the mode in which the tap water is connected with the water tank, that is, the water inlet pipe 210 is connected with the refilling pipe 215, so that if the water level of the water tank is lowered, the water tank is refilled with the tap water.

According to the fourth embodiment of the present invention, the water tank is refilled with the tap water, but the tap water and the water tank are complementary to each other and used as the water supply source. That is, if the first solenoid valve of FIGS. 6a to 6c arc at the closed mode in which the connection of the water tank, the tap water and the pump is closed, at the water tank connection mode in which the water tank and the pump are connected with each other and the connection of the water tank with the tap water is closed, and at the tap water connection mode in which the tap water and the pump are connected with each other and the connection of the tap water with the water tank is closed, the spray apparatus according to the present invention can utilize the tap water and the water tank in the complementary relation to each other as the water supply source.

On the other hand, the first embodiment or the second embodiment of the present invention can be conducted independently of the third embodiment of the present invention, or the third embodiment of the present invention can be controlled sequentially after the first embodiment or the second embodiment of the present invention. That is. the first embodiment or the second embodiment of the present invention is not necessarily conducted independently of the third embodiment of the present invention, and the first embodiment or the second embodiment of the present invention is engagedly conducted organically with the third embodiment of the present invention.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A spray apparatus comprising:
a sprayer controller engagedly operating with a content reproduced so as to control a sprayer; and
the sprayer for spraying water or draining residual water under the control of the sprayer controller,
wherein the sprayer comprises:
a water inlet pipe connected to a water supply source on one end thereof and connected to a first solenoid valve on the other end thereof;
the first solenoid valve connected to the water inlet pipe on one end thereof and connected to a connection pipe on the other end thereof in such a manner as to be controlled in the connection state thereof by means of the sprayer controller;
the connection pipe connected to the first solenoid valve on one end thereof and connected to a second solenoid valve on the other end thereof;
the second solenoid valve connected to the connection pipe and a drain pipe on one end thereof and connected to a nozzle tube on the other end thereof in such a manner as to be controlled in the connection state thereof by means of the sprayer controller;
the nozzle tube connected to the second solenoid valve on one end thereof and connected to nozzles on the other end thereof; and
the drain pipe connected to the second solenoid valve on one end thereof and having a drain hole formed on the other end thereof.

2. The spray apparatus according to claim 1, wherein through the control of the sprayer controller, the first solenoid valve is controlled to a first mode so that the water inlet pipe and the connection pipe are connected with each other or to a second mode so that the water inlet pipe and the connection pipe are closed.

3. The spray apparatus according to claim 2, wherein through the control of the sprayer controller, the second solenoid valve is controlled to a first mode so that the connection pipe and the nozzle tube are connected with each other or to a third mode so that the drain pipe and the nozzle tube are connected with each other.

4. The spray apparatus according to claim 3, further comprising a pump located on the water inlet pipe or the connection pipe to pump the water supplied.

5. The spray apparatus according to claim 4, further comprising an auxiliary pump located on the drain pipe to pump the drained water.

6. The spray apparatus according to claim 1, wherein the water supply source is a water tank or a tap water pipe.

7. A method for controlling the spray apparatus according to claim 1, the method comprising the steps of:
(a) controlling the first solenoid valve to the first mode so that the water inlet pipe and the connection pipe are connected with each other and controlling the second solenoid valve to the first mode so that the connection pipe and the nozzle tube are connected with each other to start spraying; and
(b) controlling the second solenoid valve to the third mode so that the drain pipe and the nozzle tube are connected with each other to drain the residual water remaining in the nozzle tube.
